(19) United States
(12) Patent Application Publication
(10) Pub. No.: US 2018/0197413 A1
(43) Pub. Date: Jul. 12, 2018

(54) CONTROLLING PARKING ROOM FOR VEHICLES

(71) Applicant: FORD GLOBAL TECHNOLOGIES, LLC, Dearborn, MI (US)

(72) Inventors: Frederic STEFAN, Aachen (DE); Alain Marie Roger CHEVALIER, Henri-Chapelle (BE); Michael MARBAIX, Haillot (BE); Evangelos BITSANIS, Aachen (DE)

(73) Assignee: FORD GLOBAL TECHNOLOGIES, LLC, Dearborn, MI (US)

(21) Appl. No.: 15/865,780

(22) Filed: Jan. 9, 2018

(30) Foreign Application Priority Data
Jan. 9, 2017 (DE) 10 2017 200 196.8

(51) Int. Cl. G08G 1/14; G08G 1/065

(52) U.S. Cl. CPC G08G 1/147; G08G 1/143; G08G 1/065

(57) ABSTRACT

A method to manage a parking area by a system in connection with the vehicle is provided. The system is designed to enter into connection with a vehicle that is looking for a parking space, and to assign a parking position to the vehicle. The system registers available parking room on the basis of an entropy calculation, wherein, within a parking area, both an a priori entropy prior to parking the vehicle and an a posteriori entropy are evaluated for a specific parking position, in order for a parking position to be assigned to the vehicle that brings about the lowest possible entropy on the parking area.

### CROSS-REFERENCE TO RELATED APPLICATION

This application claims foreign priority benefits under 35 U.S.C. § 119(a)-(d) to DE Application 10 2017 200 196.8 filed Jan. 9, 2017, which is hereby incorporated by reference in its entirety.

### TECHNICAL FIELD

The disclosure relates to a method to manage parking areas for vehicles with a system that registers available parking room on the basis of an entropy calculation.

### BACKGROUND

In urban areas in particular, finding a parking space for a vehicle can entail a high expenditure of time and energy. One problem here is that of finding a suitable parking area with a free parking space. A further problem is that space is often wasted, i.e. not used effectively, between vehicles that have already been parked. Reasons for this include, for example, the fact that many drivers leave a large space between other vehicles standing in front of and behind the vehicle for the sake of conveniently leaving the parking space. A further problem is that relatively small vehicles frequently occupy parking spaces that would be more suitable for a larger vehicle. In other cases, a large vehicle occupies a parking space that would be more suitable for two smaller vehicles. Not least, occupancy of a parking area is a dynamic process, in which sections of non-usable parking room develop over the course of time on a parking area that was originally used optimally as a result of vehicles of different sizes driving away and newly arriving. The object therefore arises of managing parking areas more efficiently.

### SUMMARY

This object is fulfilled by a method having the features of the principal claim. Further advantageous embodiments and forms of the disclosure emerge from the subsidiary claims, the figures and from the exemplary embodiments.

A first aspect of the disclosure relates to a method to manage at least one parking area for vehicles by a system that is designed to register parking room available within the parking area and, on the basis of an algorithm that is implemented in the system, to ascertain a parking entropy, with the steps of
structuring a region with parking spaces in at least one geographic zone whose form, size and situation is scalable and which can be dynamically edited in terms of a geographic coordinate,
structuring the geographic zone into at least one parking area, which is provided entirely for parking vehicles,
determining three classes of parking room c1, c2 and c3 within the parking area, wherein c1 represents used parking room, c2 usable parking room, and c3 non-usable parking room,
calculating a parking entropy using the formula

$$Entropy ( P ) = {\sum }_{i = 1}^{c} - pi {log}_{2} {p}_{i}$$

wherein P is the parking area,

pᵢ is the ratio of the parking room classes c1, c2 and c3 in the parking area P,

log₂ pᵢ is a logarithm of pᵢ to the base 2,

c: is the number of classes that have been determined for the parking area, where c=3,
ascertaining a homogeneous distribution of the parking area utilization on the basis of the ascertained entropy,
registering data relating to a vehicle that is looking for a parking space, and
assigning a parking space to the vehicle within the parking area with the lowest entropy value.

A parking entropy is advantageously ascertained in the method according to the disclosure, on the basis of which a utilization of a parking area is assessed. In other words, the parking entropy permits an assessment of a parking space order in terms of utilization by parking vehicles. Through the definition of the parking space utilization, it is possible to assess, with the parking entropy, how optimum a use of a parking area is, wherein a non-usable parking space arises through non-optimum utilization. The parking entropy here has a similar form to the Shannon entropy and/or the Boltzmann entropy.

A region with parking spaces here is an urban region with a number of traffic routes in which, or in whose environment, facilities for parking vehicles are present. A size of non-usable parking areas is particularly advantageously reduced with the method.

A geographic zone is a zone within the said region, where a size of a zone is dynamically changeable as a function of a position of a vehicle seeking a parking space. A geographic zone can, for example, be three roads wide surrounding the vehicle, where the roads naturally change with movement of the vehicle. A geographic zone can also comprise a parking block, multiple floors of a parking block, or an underground facility for parking, when the searching vehicle approaches a parking space.

A parking area comprised within a geographic zone is exclusively provided for parking vehicles. Restrictions at certain times, caused for example by construction work, are possible here. The parking area does not comprise any sections in which parking is forbidden. A parking area can, for example, be a road with parking spaces or a conventional parking space. A parking area can here be assigned to more than one geographic zone. Parking areas can be stored in navigation maps and/or can be called up from particular servers.

The term parking room refers to area-related information for assessing a space inside the parking area that is usable for parking.

A used parking room c1 is currently occupied by parked vehicles, wherein, in addition to the dimensions of a vehicle, a front, rear and side surroundings that are required for the vehicle to leave the parking room are also included. A usable parking room c2 is bounded by two used parking rooms c1, or by one used parking room c1 and an edge of the parking area, where c2 is greater than a specific size that is suitable for parking a vehicle. A non-usable parking room c3 is bounded by two used parking rooms c1, or by one used parking room c1 and an edge of the parking area, where c3 is not greater than a specific size that is suitable for parking a vehicle. A classification is used to determine an a priori parking entropy, i.e. what the parking entropy is before the vehicle is parked. An a posteriori parking entropy is then ascertained for all or a plurality of usable parking rooms which the vehicle that is searching for a parking space could take.

The entropy ascertained is used as a measure of how homogeneous use of a parking area is in terms of three parking room classes. The entropy is equal to zero if all the parking rooms within a parking area belong to the same class of parking room c1 or c2. In this case the parking area has an ideal state. The parking area cannot exclusively consist of parking room of class c3.

Preferably vehicle-related data includes a size of the vehicle. The size here is advantageously included in the ascertainment of the usable parking room that is present, since the classification of the parking room into usable, occupied and non-usable can be refined in that way. The vehicle-related data furthermore includes a position (e.g. GPS data) of the vehicle.

Advantageously in the method on the basis of geographic zones ascertained, suitable parking regions, and a location of the vehicle, and a number of parking spaces suitable for the vehicle are selected. In other words, parking spaces that, for example, exhibit adequate usable parking room and whose entropy lies below a predetermined value, also referred to as a threshold value, are selected.

It is preferred here if an a posteriori entropy is ascertained in the parking area with reference to various parking spaces that could be taken by the vehicle, and is carried out with reference to the classification of the parking rooms.

Preferably one or more parking places are sought in the method, whose selection is based on a criterion that is based on at least one of the conditions:
smallest a posteriori entropy for a parking area,
a posteriori entropy below a threshold value for a particular parking position within a parking area,
presence of at least one usable parking room,

or a combination of the conditions.

The said threshold value is here preferably a dynamic value that is a function of a current average parking entropy of the geographic zone, a current traffic conditions, a current need for parking space, a prediction of the need for parking space and/or a size of the available parking room.

Preferably, when the criterion of the lowest a posteriori entropy is satisfied by a plurality of parking positions, the parking position that can be reached with the lowest output of energy is preferred.

Alternatively or in addition to the lowest possible energy expenditure, when the criterion of the lowest a posteriori entropy is satisfied, the parking space whose use most reduces the non-usable parking room is preferred.

In the method, an arrangement of vehicles parked within the parking area is preferably optimized for a provision of usable parking room as a function of at least one of the following conditions, even if no vehicle requires a parking space at the time:
there is no usable parking room available,
a particular used parking room is used,
the parking entropy is above a threshold value,
a particular traffic condition is present,
there is a particular parking space requirement,
a particular parking space requirement is forecast.

A value for the size of the vehicle can be specified here, for example a mean value that corresponds to an average vehicle size and/or expected size. It is also possible for different sizes to be given, e.g. compact car, mid-range car, truck and the like.

The disclosure is explained in more detail with reference to the Figures.

### BRIEF DESCRIPTION OF THE DRAWINGS

FIG. 1 shows a modular illustration of a form of embodiment of the method according to the disclosure.

FIG. 2 shows a flow diagram of a form of embodiment of the method according to the disclosure.

FIG. 3 shows an illustration of a geographic zone.

FIG. 4 shows an illustration of an entropy status of a parking area.

FIG. 5A-E shows an illustration of different entropy statuses of parking areas.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Parking areas within a specific region are regulated and a parking space assigned to a vehicle that is seeking a parking space with the method according to the disclosure. A system is used for this which registers parking room within the parking areas and is in connection with the vehicle on the basis of an algorithm that is implemented in the system, and ascertains a parking room entropy.

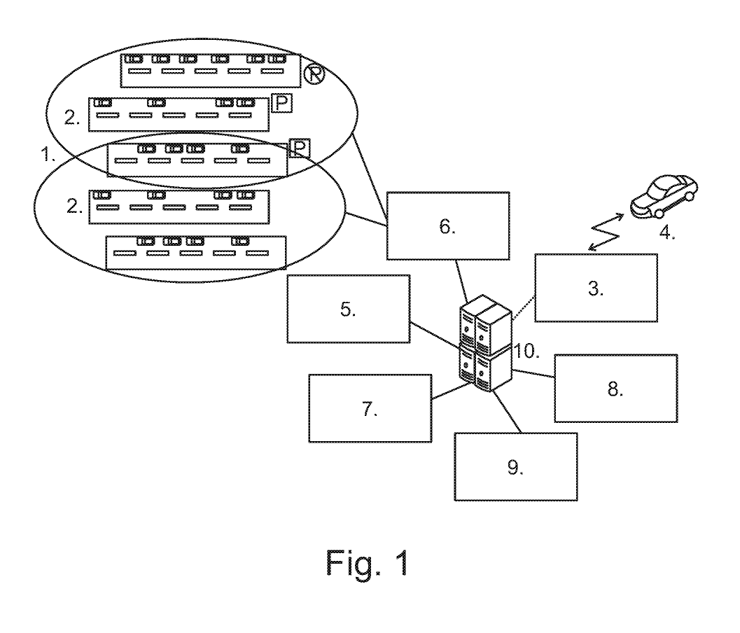

The method can be illustrated in accordance with the illustration of FIG. 1 in the form of a central logic, wherein a central unit 10 coordinates the system. The system is illustrated here in modular form. The parking region 1 in the illustration comprises two geographic zones 2. The geographic zones 2 here each comprise three parking areas, while one parking area belongs to both geographic zones 2. The geographic zones 2 accordingly overlap.

The system comprises a communication module 3, which is in connection with a vehicle 4. The vehicle 4, or its driver, is searching for a parking space. A connection is established between the vehicle and the system. The vehicle provides its position (e.g. GPS coordinates) and its size, in particular its length and width, to the system.

A classification module 5 classifies the parking areas into usable c1, used c2 and non-usable parking room c3. Data such as a size of the vehicle 4 can be included in the classification process.

A utilization module 6 determines a current utilization of the parking areas in terms of the classification of the parking rooms into c1, c2 and c3. The information can be fetched regularly from a central installation by which the parking areas are monitored, and/or from vehicles that are parked within the parking area (using the vehicle's on-board sensors or a communication system between the infrastructure and the vehicle).

A determination module 7 determines geographic zones 2 and suitable parking areas P for the vehicle that is to be parked. The determination module 7 chooses at least one suitable parking area on the basis of the classification of the parking rooms and the position of the vehicle 4. This means that the parking area satisfies specific criteria that make it suitable for parking, for example that a suitable space is available and the current parking entropy lies below a specific, predetermined threshold value. In other words, a preselection of suitable parking areas takes place.

A calculation module 8 ascertains the a posteriori parking entropy for each preselected parking area. This involves a calculation of which parking positions are suitable for the vehicle 4, wherein the classification of the parking rooms is taken into account.

A selection module 9 selects at least one, and in appropriate cases also a plurality of suitable parking positions for the vehicle. The selection is based here on at least one criterion for optimization, or on a combination of appropriate criteria. The lowest a posteriori parking entropy can, for example, be chosen as the criterion. A threshold value can, furthermore, be predetermined for the a posteriori parking entropy, e.g. 0.8, which the entropy must stay below. If a plurality of spaces can be used under both above-mentioned criteria, the space which requires a lowest energy expenditure for the vehicle to reach it and/or reduces a number of non-usable parking spaces is selected. It can also be a criterion that at least one usable space is present.

In an alternative form of embodiment, the selection module 9 can also optimize the arrangement of vehicles parked in the parking room for the provision of usable parking room, even if no vehicle requires a parking space at the time. The arrangement is optimized here if at least one of the following conditions applies: no usable parking spaces are available, a specific parking space is used, the parking entropy is above a threshold value, a particular traffic condition is present, there is a particular parking space requirement, and/or a specific parking space requirement is forecast.

The central unit 10 is, ideally, implemented in a control apparatus.

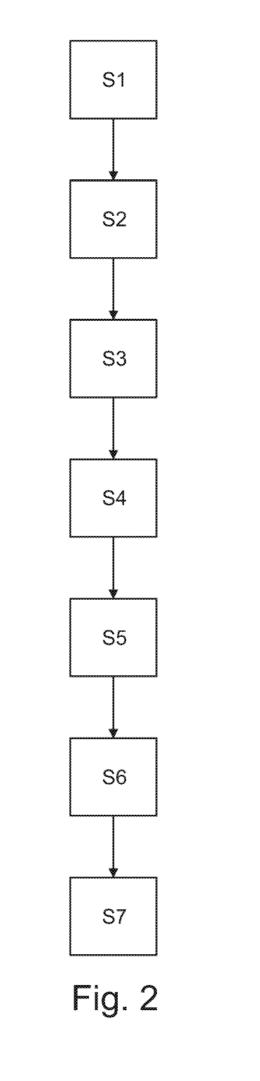

According to the form of embodiment of the method according to the disclosure illustrated in FIG. 2, the region 1 with parking spaces is structured in a first step S1 into at least one geographic zone 2, or is also structured or divided into a number of geographic zones 2, whose shape, size and situation are scalable and can be edited dynamically in reference to a geographic coordinate. The region 1 can thus comprise only one geographic zone 2, or two, three or any number of geographic zones 2. In a second step S2, the geographic zone 2 or zones 2 is or are each divided into at least one parking area P that is provided entirely for the parking of vehicles. A geographic zone 2 here can also comprise only one parking area P, or two, three or any number of parking areas P. The division of a region 1 into geographic zones 2 and parking areas P can be stored in maps and/or navigation systems, wherein the division can also change dynamically as a function of parking space requirement.

Three classes of parking room, referred to as c1, c2 and c3, are determined in a third step S3. The three classes are used to classify parking room within at least one parking area P, wherein c1 represents used parking room, c2 usable parking room, and c3 non-usable parking room. The classification of the parking rooms can be carried out on the basis of measured values from static sensors, or also on the basis of values that are ascertained through sensors in the parking vehicles and are ascertained at other vehicles or a corresponding infrastructure. The classification is used to determine an a priori parking entropy. An a posteriori parking entropy is then ascertained for all or a plurality of parking rooms, which the vehicle that is searching for a parking space could take.

A parking room entropy is calculated in a fourth step S4. For this purpose, the formula
is used,

$$Entropy ( P ) = {\sum }_{i = 1}^{c} - pi {log}_{2} {p}_{i}$$

where P is the parking room, pᵢ the ratio of the parking room classes c1, c2 and c3 in the parking room P, log₂ pᵢ is a logarithm of pᵢ to the base 2, and c is the number of classes that have been determined for the parking room P, where c=3.

A homogeneous distribution of the parking room utilization is ascertained on the basis of the ascertained entropy in a fifth step S5. The system registers vehicle-related data, for example the size of the vehicle, i.e. in particular the dimensions of the length and width, in a sixth step S6. The system can, furthermore, register a current position of the vehicle. GPS data is, for example, transmitted from the vehicle to the system for this purpose.

In a seventh step S7, a parking space for which the lowest entropy value is ascertained is assigned within a parking room to the vehicle.

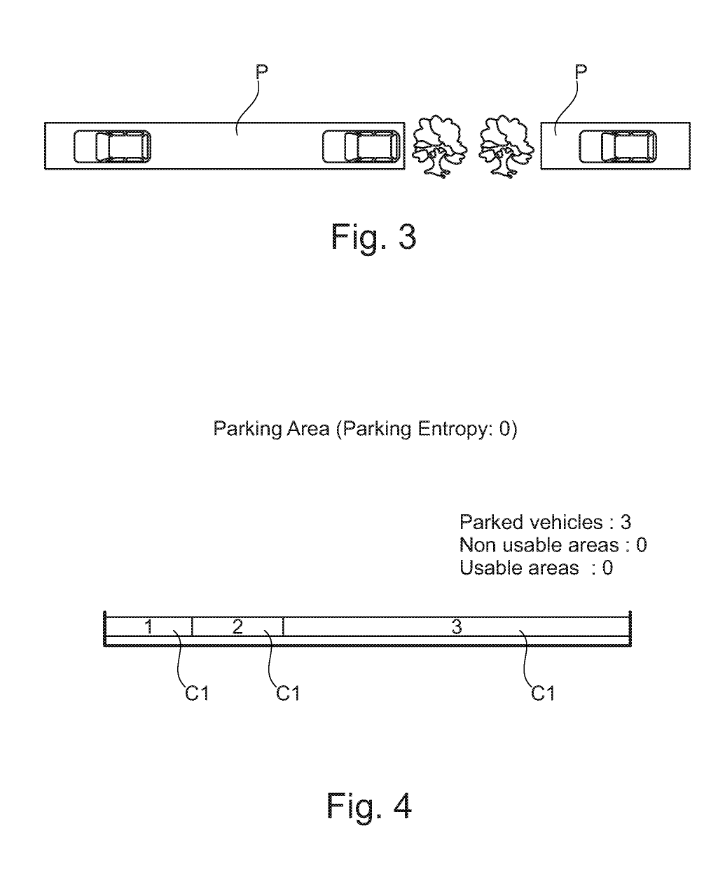

A geographic zone having two parking areas is illustrated by way of example in FIG. 3. A parking area is used for parking vehicles, and is provided here entirely for this purpose. A parking area is, for example, a road with parking facilities on one or both sides of the road, or a conventional parking space. So-called forbidden zones, in which parking is not possible, as is illustrated in FIG. 3 by a group of trees, divide the zone into two different parking areas.

If a parking area P is fully occupied or fully free, i.e. if it only has parking room classes c1 or c2, the entropy is equal to zero. In these cases the parking area has an ideal state. A parking area that only has used parking room c1 is illustrated in FIG. 4. In FIGS. 4, c1=3, c2=0 and c3=0.

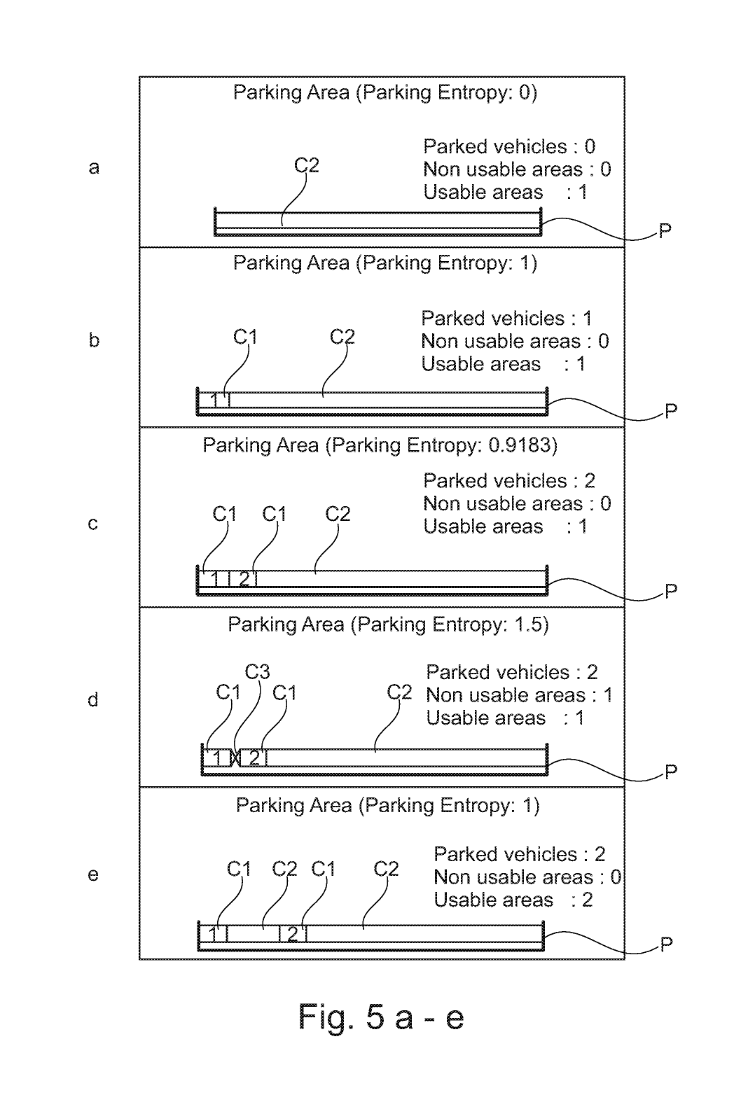

Further examples of possible parking area utilizations are illustrated in FIGS. 5A-E. In FIG. 5A the parking area is not occupied by a vehicle, and the parking area is entirely free. Here c1=0, c2=1 and c3=0. The parking entropy is equal to zero.

In FIG. 5B a vehicle is parked on the parking area. The parking area thus has one used space and one unused space, so that c1=1, c2=1 and c3=0. The parking entropy is now equal to one.

In FIG. 5C, two vehicles are parked one behind the other on the parking area. The second vehicle is sitting immediately behind the first (with a clearance that is necessary for leaving the parking space). The parking area thus has two used spaces and one unused space, so that c1=2, c2=1 and c3=0. The parking entropy is now equal to 0.9183.

In FIG. 5D, two vehicles are parked one behind the other on the parking area. Between the two vehicles there is a space that is not necessary for leaving the parking space, but this is not large enough to offer a space for a further vehicle. This space between the vehicles is not usable for parking, and belongs to class c3. The parking area thus has two used spaces, one unused space and one non-usable space. Thus c1=2, c2=1 and c3=1. The parking entropy is now equal to 1.5.

In FIG. 5E two vehicles are parked on the parking area. The first vehicle is at the edge, and the second vehicle is positioned at an arbitrary place on the parking area, and at least one usable space is present between the vehicles and behind the second vehicle. There are therefore two usable spaces. Here c1=2, c2=2 and c3=0. The parking entropy is now equal to 1.

The parking entropy of the example in FIG. 5E is higher than the parking entropy in FIG. 5C. The parking entropy thus makes clear that in FIG. 5C a distribution of the vehicles over the parking area is better than it is in FIG. 5E.

A space is assigned to a vehicle that is looking for a parking space, which, under given circumstances, leads to the lowest possible entropy over the parking area. If the second vehicle were an incoming vehicle that is looking for a parking space, it would be assigned a parking space according to FIG. 5C. This would ensure the most homogeneous possible utilization of the parking area.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to manage parking for vehicles comprising:
structuring a region with parking spaces in at least one geographic zone, wherein the geographic zone includes a form, a size and situation that is scalable and is dynamically edited in terms of a geographic coordinate;
structuring the geographic zone in at least one parking area provided entirely for parking vehicles;
determining three parking room classes within the parking area;
calculating a parking entropy using the parking area, and a ratio of the parking room classes in the parking area;
ascertaining a homogeneous distribution of a parking area utilization from the parking entropy;
registering data relating to a vehicle that is looking for a parking space; and
assigning a parking space to the vehicle within the parking area with a low entropy value.

2. The method as claimed in claim 1, wherein the data includes a size and position of the vehicle.

3. The method as claimed in claim 1, wherein the data includes a position of the vehicle.

4. The method as claimed in claim 1 further comprising selecting, based on the geographic zones, suitable parking regions, and a location of the vehicle, a number of parking spaces suitable for the vehicle.

5. The method as claimed in claim 1, wherein determining three parking room classes includes ascertaining an a posteriori entropy in the selected parking areas with reference to various parking positions that could be taken by the vehicle.

6. The method as claimed in claim 1 further comprising selecting one or more parking positions based on
a criterion defined by at least one of a smallest a posteriori entropy for a parking area,
an a posteriori entropy below a threshold value for a particular parking position within a parking area, or
a presence of at least one usable parking room.

7. The method as claimed in claim 6, wherein the threshold value is a dynamic value that is a function of a current average parking entropy of the geographic zone, a current traffic condition, a current need for parking space, a prediction of the need for parking space and the size of the usable parking room.

8. The method as claimed in claim 6 further comprising, when the a posteriori entropy is below the threshold, reaching the parking position with a low output of energy.

9. The method as claimed in claim 6 further comprising preferring, when the a posteriori entropy is below the threshold, the parking space that reduces a non-usable parking room.

10. The method as claimed in claim 1 further comprising adjusting an arrangement of vehicles parked within the parking area as a function of at least one condition, the condition being one of no usable parking room available, a parking room is used, the parking entropy is above a threshold value, a particular traffic condition is present, a particular parking space requirement, and a particular parking space requirement is forecast.

11. A vehicle comprising:
a unit, communicable with a parking system, designed to,
in response to a region structured with spaces in a zone having a form, size and situation scalable and dynamically edited from a coordinate, define an area, and,
in response to a lowest entropy for a space calculated from the area and a ratio of parking classes within the area, assign the space to the system.

12. The vehicle as claimed in claim 11, wherein the unit is further designed to, in response to a posteriori entropy being less than a threshold and a presence of a usable parking room, select a parking position within the area.

13. The vehicle as claimed in claim 12, wherein the unit is further designed to, in response to the a posteriori entropy being below the threshold, actuate the parking system to reach the parking position with minimal energy consumption.

14. The vehicle as claimed in claim 12, wherein the unit is further designed to, in response to the a posteriori entropy being below the threshold, set a preference to the position that reduces a non-usable parking room.

15. The vehicle as claimed in claim 11, wherein the parking system is designed to, in response to no usable parking room available, a used parking room, the entropy being above a threshold value, a particular traffic condition being present, a particular parking space requirement, or a forecast of a particular parking space requirement, adjust an arrangement of vehicles parked within the area.

16. A parking management system comprising
a determination module designed to structure a region with parking spaces in a geographic zone, wherein the geographic zone includes a form, a size and situation that is scalable and is dynamically edited in terms of a geographic coordinate, such that a parking area is defined;
a classification module designed to determine three parking room classes within the parking area;
a calculation module designed to calculate a parking entropy using the parking area, and a ratio of the parking room classes;
an utilization module designed to ascertain a homogeneous distribution of a parking area utilization from the parking entropy; and
a selection module designed to assign a parking space to the vehicle within the parking area with an entropy value being a lowest value of parking entropy.

17. The parking management system as claimed in claim 16, wherein the calculation module is further designed to select a parking position within the area based on a posteriori entropy being less than a threshold and a presence of a usable parking room.

18. The parking management system as claimed in claim 17, wherein the selection module is further designed to reach the parking position with minimal energy consumption based on the a posteriori entropy.

19. The parking management system as claimed in claim 17, wherein the selection module is further designed to prefer the position that reduces a non-usable parking room.

20. The parking management system as claimed in claim 16, wherein the utilization module is designed to adjust an arrangement of vehicles parked within the area when no usable parking room is available, a used parking room, the entropy being above a threshold value, a particular traffic condition being present, a particular parking space requirement, or a forecast of a particular parking space requirement.
